(19) United States
(12) Patent Application Publication
(10) Pub. No.: US 2011/0100303 A1
(43) Pub. Date: May 5, 2011

(54) BECKKY-BOARD, THE WALK-OVER NAIL-FILING MAT FOR DOGS SYSTEM

(76) Inventor: Becky Borgstrand, Prunedale, CA (US)

(21) Appl. No.: 12/917,291

(22) Filed: Nov. 1, 2010

Related U.S. Application Data
(60) Provisional application No. 61/257,328, filed on Nov. 2, 2009.

(51) Int. Cl. A01K 13/00

(52) U.S. Cl. 119/601; 119/600

(57) ABSTRACT

A walk over nail filing mat for pets comprising: a filing layer comprising a fiberglass sanding screen for filing and trimming a pet's nails, a bamboo backing layer comprising ½″ wide slats, which allow the device to be easily rolled up for transport or storage, and a border made of fabric. The filing layer is attached to the backing layer and surrounded via the border made of fabric. The filing layer serves as a nail file to trim a pet's nails when a pet walks over the walk over nail filing mat for pets.

### CROSS-REFERENCE TO RELATED APPLICATION

The present application is related to and claims priority from prior provisional application Ser. No. 61/257,328, filed Nov. 2, 2009 which application is incorporated herein by reference.

### BACKGROUND OF THE INVENTION

1. Field of the Invention

The present invention relates generally to the field of pet care and grooming devices and more specifically relates to an animal nail filing device, a walk-over nail-filing mat for dogs.

2. Description of the Related Art

Cutting a dog's nails may be a traumatic and unpleasant procedure which unfortunately has to be performed to retain the health of a dog. Not maintaining a dog's health is a problem and in the case of paws and nails can lead to overgrown nails. Overgrown nails can cause health hazards such as splayed toes, joint damage, and painful ingrown nails. A further hazard is that the long nails can cause damage to furniture, floors and carpeting. Many pet owners have to live with scratched and damaged furniture, floors and even clothing.

To obviate this and to prevent negative effects to the dog's health, dog owners, veterinarians and groomers all struggle to cut and file toenails of dogs who typically hate having this procedure done. Dog owners generally are not properly equipped to perform this task and fear that they will injure the animal's paws by cutting into the nerve and blood vessels of the nails causing the animal pain and suffering. Because of this, dogs are often taken to a vet or dog groomer to have their nails cut and the vet has often to resort to sedating the animal so that the procedure can be carried out with a minimum amount of stress.

A need exists for a device which facilitates a painless and efficient process that will keep a dog's nails short and smooth. Additionally the need exists for a device that will help the dog retain a short and smooth nail and which simultaneously provides the dog and dog owner with a pleasant stress-free method for maintaining short and smooth nails.

Various attempts have been made to solve the above-mentioned problems such as those found in U.S. Pat. Nos. 6,827,038, 7,137,356, 2008/0099032, 7,621,011, 5,819,757, and 2007/0089686. This prior art is representative of pet care and grooming devices. None of the above inventions and patents, taken either singly or in combination, is seen to describe the invention as claimed.

Ideally, a nail filing device should be an unobtrusive experience for the dog and the dog owner without any unpleasant side effects, obviate a visit to the vet or pet groomer on a regular basis, be cost efficient, and be manufactured at a modest expense. Thus, a need exists for a nail file which the dog is not aware of when in use and which avoids the above-mentioned problems.

### BRIEF SUMMARY OF THE INVENTION

In view of the foregoing disadvantages inherent in the known pet care and grooming devices art, the present invention provides a novel animal nail filing device. The general purpose of the present invention, which will be described subsequently in greater detail, is to provide a nail filing system which the animal is not aware of when in use.

A walk over nail filing mat for pets is disclosed herein, comprising: a filing layer, a backing layer having a border around the outer edges. The filing layer is attached to the backing layer so that they form a unit assembly. Additionally, the border may be made of fabric is attached to the perimeter of the unit.

The filing layer may have a fiberglass sanding screen for filing and trimming a pet's nails thereby permitting at least one cat or dog to walk over the filing layer and simultaneously file and trim their nails without any stressful emotions or side effects. The filing layer thereby serves as a nail file when a pet walks over the walk over nail filing mat for pets.

The backing layer preferably comprises bamboo. The bamboo backing layer preferably comprises ½″ wide slats, which allow the device to be easily rolled up for lightweight transport or storage.

A kit is embodied herein for the beckky-board, the walk-over nail-filing mat for dogs system comprising: various versions of the walk over nail filing mats for pets may be available comprising various degrees of coarseness and various designs.

In accordance with the embodiments of the present invention a preferred method of use is also disclosed herein comprising: placing a walk over nail filing mat for pets comprising a filing layer with a friction-abrasive surface and a backing layer on a floor in a part of a house which is frequently used by a pet; having the pet walk over a friction-abrasive surface of the walk over nail filing mat for pets, thereby having the pet's nails filed through the movement of the pet's nails on the friction-abrasive surface suitable for filing and trimming a pet's nails; rolling up the walk over nail filing mat; and storing the walk over nail filing mat.

The present invention holds significant improvements and serves as a walk-over nail-filing mat for dogs system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, beckky-board, the walk-over nail-filing mat for dogs system, constructed and operative according to the teachings of the present invention.

FIG. 1 shows a perspective view illustrating a walk over nail filing mat for pets in an ‘in-use’ condition according to an embodiment of the present invention.

FIG. 2 shows another perspective view illustrating the walk over nail filing mat for pets in an ‘in-use’ condition according to an embodiment of the present invention of FIG. 1.

FIG. 3 is a perspective view illustrating the walk over nail filing mat for pets comprising a fine fiber surface and a bamboo backing and another walk over nail filing mat for pets comprising a large fiber surface according to an embodiment of the present invention of FIGS. 1 and 2.

FIG. 4 is a perspective view illustrating the walk over nail filing mat for pets rolled up for easy storage according to an embodiment of the present invention of FIGS. 1-3.

FIG. 5 is a perspective view illustrating a decorative animal print on the walk over nail filing mat for pets according to an embodiment of the present invention of FIGS. 1-4.

FIG. 6 is a flowchart illustrating a method of use according to an embodiment of the present invention of FIGS. 1-5.

The various embodiments of the present invention will hereinafter be described in conjunction with the appended drawings, wherein like designations denote like elements.

### DETAILED DESCRIPTION

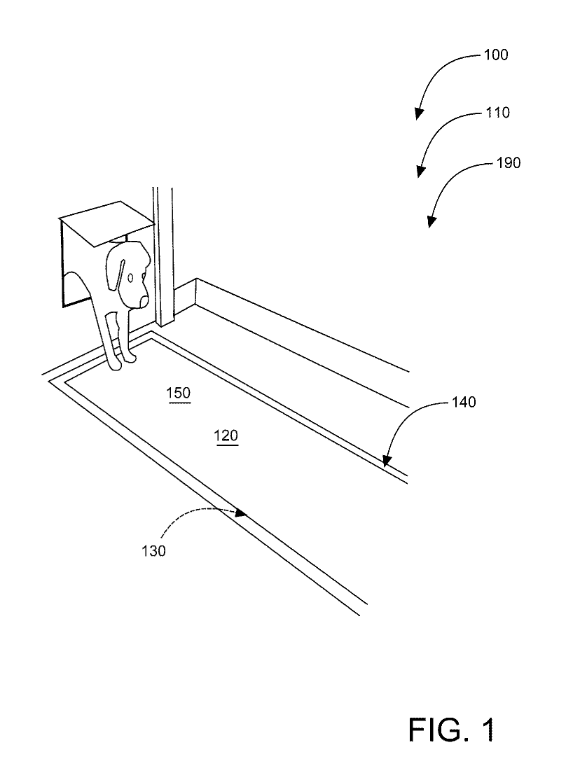

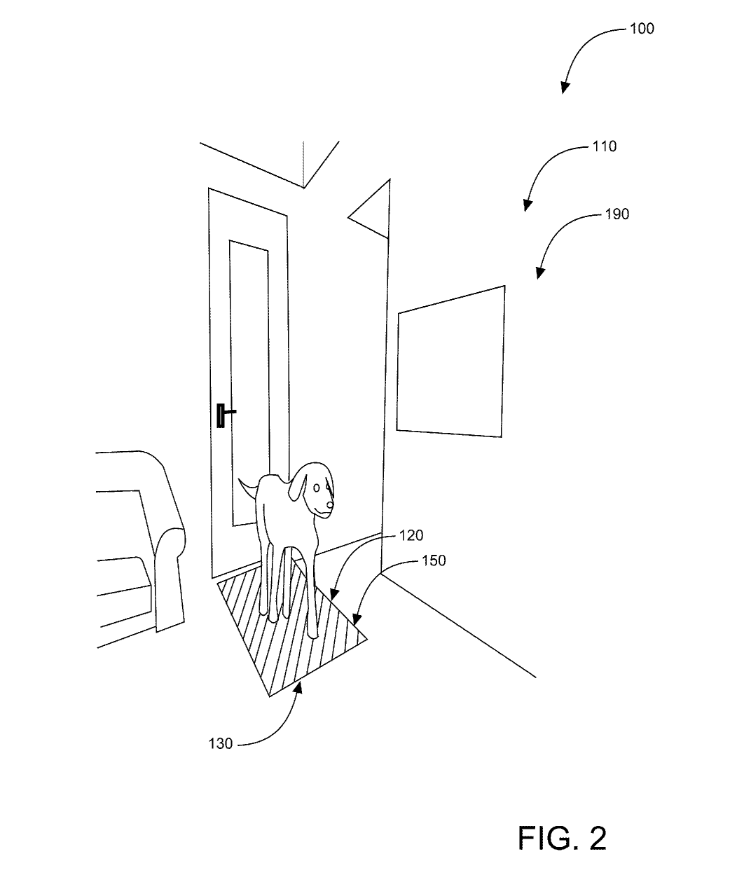

As discussed above, embodiments of the present invention relate to an animal nail filing device and more particularly to a walk over nail filing mat for pets as used to improve the experience of filing and trimming a pets nails. Referring to the drawings by numerals of reference there is shown in FIGS. 1 and 2, a perspective view illustrating walk over nail filing mat for pets 110 in ‘in-use’ condition 190 according to an embodiment of the present invention.

Walk over nail filing mat for pets 110 is disclosed herein comprising: filing layer 120, backing layer 130, and border 140 made of fabric wherein filing layer 120 is attached to backing layer 130 and surrounded via border 140 made of fabric. Filing layer 120 preferably serves as a nail file when a pet walks over walk over nail filing mat for pets 110 thereby creating ‘in-use’ condition 190.

Walk over nail filing mat for pets 110 is preferably of rectangular shape and thereby suitable for placement in a passage or corridor which an animal uses frequently. Walk over nail filing mat for pets 110 may further be fabricated in various sizes such as hallway runners, square cuts, special orders, and other shapes and sizes to accommodate preferences of user 180.

Filing layer 120 within this particular embodiment preferably comprises a fiberglass sanding screen for filing and trimming a pet's nails. When an animal walks over filing layer 120, the friction caused by the movement of the claws on the friction-abrasive surface 150 of filing layer 120 results in a filed and trimmed nail surface without the animal experiencing any stress occasioned by this experience. Thereby the walk over nail filing mat for pets 110 acts as a giant nail file, dulling and gradually reducing long nails to a comfortable, safe and healthy flat-paw level. The walk over nail filing mat for pets 110 allows dog owners to painlessly file long nails, keeping pets comfortable and owners free from scratches.

Walk over nail filing mat for pets 110 further comprises backing layer 130 which preferably comprises bamboo material. Backing layer 130 preferably comprises ½″ wide bamboo slats, which allow the device to be easily rolled up for transport or storage. The preferred material comprises bamboo, which has the ability to deter dogs from chewing on it. However, backing layer 130 is not limited to bamboo material. Another suitable alternative to bamboo is Dura Runner Plus manufactured from Productive Products. In certain other embodiments backing layer 130 may comprise carpet with a protective plastic layer, vinyl or rubber. These materials have the attribute of being non-slip and thereby facilitate a secure placement of walk over nail filing mat for pets 110 on the floor.

Filing layer 120 and backing layer 130 are preferably attached to each other thereby forming a unit. Filing layer 120 and backing layer 130 are preferably attached to each other via an adhesive layer or any other suitable fastening means.

Walk over nail filing mat for pets 110 further comprises fabric border 140 which is preferably attached to the perimeter of filing layer 120 and backing layer 130. Border 140 preferably comprises durable fabric and is approximately 1 inch wide. However, border 140 may be made of plastic, rubber or any other suitable and durable material. Particularly a rubber border 140 would prevent walk over nail filing mat for pets 110 from moving around on the floor while being used by a pet. Further, it should be noted that walk over nail filing mat for pets 110 may not include border 140, and is optional.

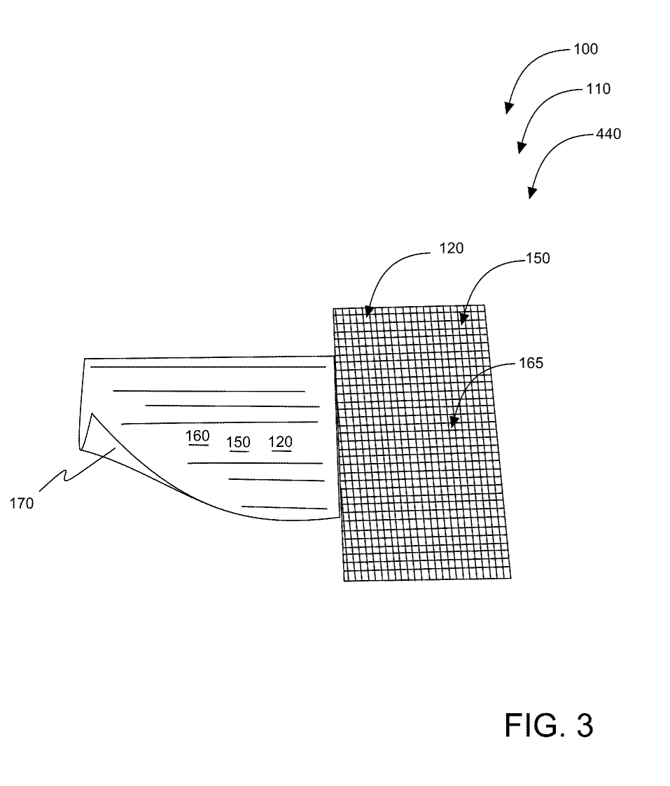

Referring now to FIG. 3, a perspective view illustrating walk over nail filing mat for pets 110 comprises fine fiber surface 160 and bamboo backing 170 and another embodiment of walk over nail filing mat for pets 110 comprising large fiber surface 165 according to an embodiment of the present invention of FIG. 1 and FIG. 2.

As mentioned before, filing layer 120 within this particular embodiment preferably comprises a fiberglass sanding screen for filing and trimming a pet's nails. When an animal walks over filing layer 120, the friction caused by the movement of the claws on the friction-abrasive surface 150 of filing layer 120 results in a filed and trimmed nail surface without the animal experiencing any stress occasioned by this experience. Filing layer 120 comprises a friction-abrasive surface 150 suitable for filing and trimming nails of a pet. Filing layer 120 may comprise a fiberglass sanding screen. The fiberglass sanding screen fabric may be available in three different grades of coarseness to suit small, medium and large dog sizes. However filing layer 120 may comprise any suitable material such as different grades of sandpaper.

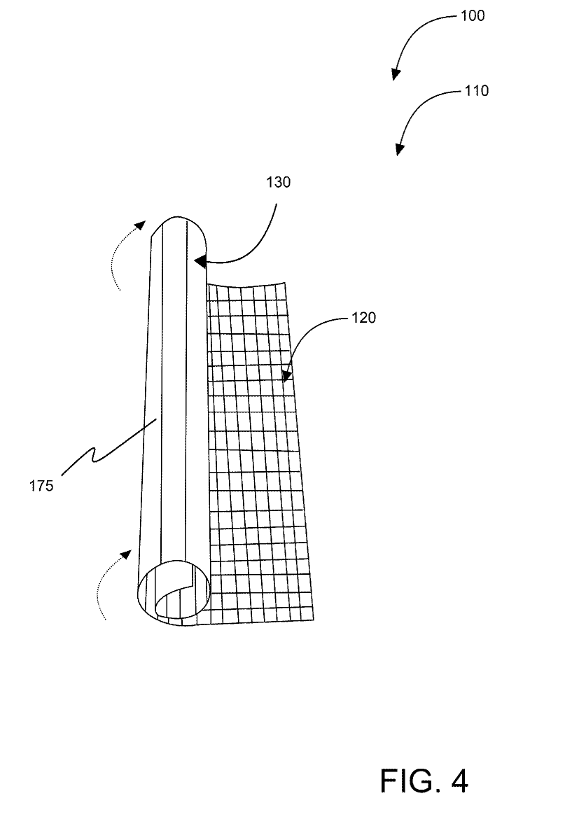

Referring now to FIG. 4, a perspective view illustrating walk over nail filing mat for pets 110 rolled up for easy storage according to an embodiment of the present invention of FIGS. 1-3.

Walk over nail filing mat for pets 110 preferably comprises flexible and rollable filing layer 120, and a flexible and rollable backing layer 130 so that walk over nail filing mat for pets 110 may easily be rolled up for storage. Walk over nail filing mat for pets 110 preferably comprises a backing layer 130 made of ½″ wide bamboo slats 175, which allow the device to be easily rolled up for transport or storage.

Beckky-board, the walk-over nail-filing mat for dogs system 100 may be sold as kit 440 comprising the following parts: various walk over nail filing mats for pets 110 wherein walk over nail filing mats for pets 110 comprise various degrees of coarseness and various designs.

Beckky-board, the walk-over nail-filing mat for dogs system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

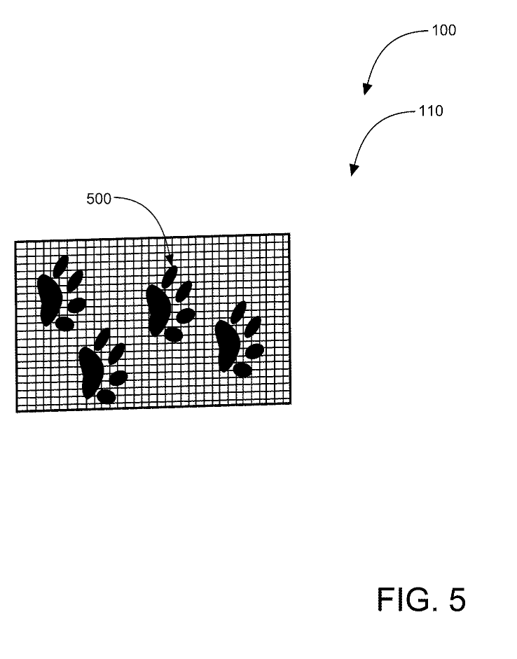

Referring now to FIG. 5, a perspective view illustrating a decorative animal print 500 on walk over nail filing mat for pets 110 according to an embodiment of the present invention of FIGS. 1-4.

Walk over nail filing mat for pets 110 may preferably be decorated with an animal print 500 increasing the aesthetic appearance of the mat. However, walk over nail filing mat for pets 110 may come in various colors and decorations.

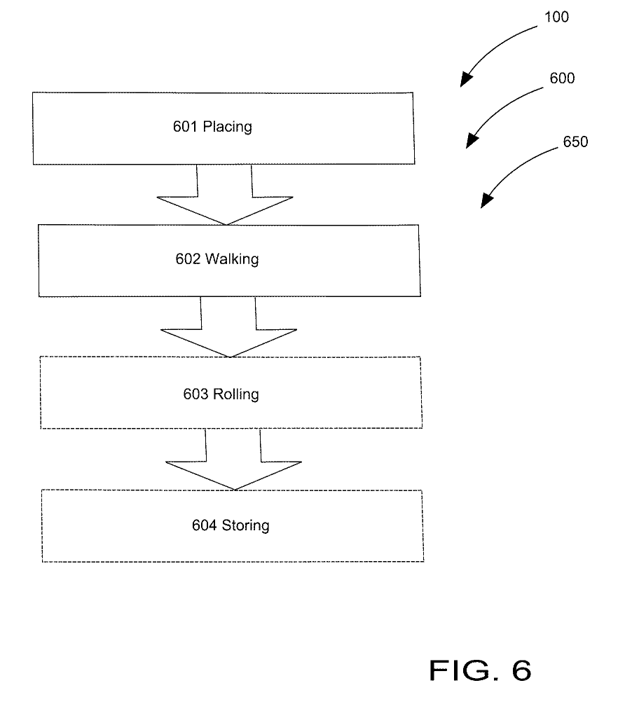

Referring now to FIG. 6, flowchart 650 illustrating method of use 600 according to an embodiment of the present invention of FIGS. 1-5.

In accordance with the embodiments of the present invention a preferred method of use 600 is disclosed herein comprising the following steps: step one 601 placing a walk over nail filing mat for pets comprising a filing layer with a friction-abrasive surface and a backing layer on a floor in a part of a house which is frequently used by a pet; step two 602 having the pet walk over a friction-abrasive surface of the walk over nail filing mat for pets, thereby having the pet's nails filed through the movement of the pet's nails on the friction-abrasive surface suitable for filing and trimming a pet's nails; step three 603 rolling up the walk over nail filing mat; and step four 604 storing the walk over nail filing mat.

It should be noted that steps three 603 and four 604 are optional steps and may not be implemented in all cases. Optional steps of method of use 600 are illustrated using dotted lines in FIG. 6 so as to distinguish them from the other steps of method of use 600.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A walk over nail filing mat for pets comprising:
a filing layer;
a backing layer; and
a border;
wherein said filing layer is attached to said backing layer and surrounded via said border; and
wherein said filing layer serves as a nail file when a pet walks over said walk over nail filing mat for pets and said backing layer allows said walk over nail filing mat for pets to be easily rolled up for storage.

2. The walk over nail filing mat for pets of claim 1 wherein said filing layer comprises a friction-abrasive surface suitable for filing and trimming nails of said pet.

3. The walk over nail filing mat for pets of claim 1 wherein said filing layer comprises a fiberglass sanding screen.

4. The walk over nail filing mat for pets of claim 1 wherein said backing layer comprises bamboo material.

5. The walk over nail filing mat for pets of claim 4 wherein said bamboo backing layer comprises ½″ wide slats, which allow the device to be easily rolled up for transport or storage.

6. The walk over nail filing mat for pets of claim 1 wherein said backing layer comprises carpet with a protective plastic layer.

7. The walk over nail filing mat for pets of claim 1 wherein said backing layer comprises vinyl.

8. The walk over nail filing mat for pets of claim 1 wherein said backing layer comprises rubber.

8. The walk over nail filing mat for pets of claim 1 wherein said border is made of fabric.

9. The walk over nail filing mat for pets of claim 1 wherein said border is made of plastic.

10. The walk over nail filing mat for pets of claim 1 wherein said border is made of rubber.

11. A walk over nail filing mat for pets comprising:
a filing layer comprising a fiberglass sanding screen for filing and trimming nails of a pet;
a bamboo backing layer comprising ½″ wide slats, which allow the device to be easily rolled up for transport or storage; and
a border made of fabric;
wherein said filing layer is attached to said backing layer and surrounded via said border made of fabric; and
wherein said filing layer serves as a nail file when a pet walks over said walk over nail filing mat for pets.

12. The walk over nail filing mat for pets of claim 11 wherein said walk over nail filing mat for pets further comprises a kit including various versions of said walk over nail filing mats for pets wherein said walk over nail filing mats for pets comprise various degrees of coarseness and various designs.

13. A method of use comprising the steps of:
placing a walk over nail filing mat for pets comprising a filing layer with a friction-abrasive surface and a backing layer on a floor in a part of a house which is frequently used by a pet; and
having said pet walk over a friction-abrasive surface of said walk over nail filing mat for pets, thereby having said pet's nails filed through the movement of said pet's nails on said friction-abrasive surface suitable for filing and trimming a pet's nails.

14. The method of claim 13 further comprising the steps of:
rolling up said walk over nail filing mat for pets; and
storing said walk over nail filing mat for pets.
